(19) United States
(12) Patent Application Publication
(10) Pub. No.: US 2005/0156932 A1
(43) Pub. Date: Jul. 21, 2005

(54) Time cues for animation

(75) Inventors: Christopher Vienneau, Montreal (CA); Juan Pablo Di Lelle, Montreal (CA); Michiel Schriever, Montreal (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/039,530

(22) Filed: Jan. 19, 2005

(30) Foreign Application Priority Data
Jan. 20, 2004 (GB) 04 01 158.1

(51) Int. Cl. G06T 15/70

(52) U.S. Cl. 345/473

(57) ABSTRACT

Apparatus for image data processing, comprising memory means, processing means, display means and manual input means, wherein said memory means includes animation data comprising a plurality of attributes each having at least one keyframe and each keyframe having a time value, and a plurality of cue points each having a time value, wherein a cue point may be associated with one or more keyframes having the same time value; wherein changing the time value of a cue point changes the time values of its associated keyframes.

### CROSS-REFERENCE TO RELATED APPLICATION

This application claims the benefit under 35 U.S.C. §119 of the following co-pending and commonly assigned foreign patent application, which application is incorporated by reference herein:

United Kingdom Application No. 04 01 158.1 entitled, “IMAGE DATA PROCESSING”, by Christopher Vienneau, Juan Pablo Di Lelle and Michiel Schriever, filed on Jan. 20, 2004.

### BACKGROUND OF THE INVENTION

1. Field of the Invention

The invention relates to image data processing in which objects are associated with animation data in order to create animated objects.

2. Description of the Related Art

Sophisticated animation applications exist in which objects are animated, often in order to provide realistic “special effects” for films. Traditionally a director will view video footage and indicate at which points he requires certain effects. An artist must stop the tape, identify the time at which the effect is required and write it down in order to place the effect in the correct place later. This is a time-consuming and sometimes error-prone process.

Further, a single animation usually comprises hundreds if not thousands of separate attributes, all of which must be synchronized in order to place the effect in precisely the right position. If the effect is to be moved such that it occurs at a different time in the video footage every attribute must be identified and separately moved. This again is a lengthy process.

### SUMMARY OF THE INVENTION

According to a first aspect of the present invention there is provided apparatus for image data processing comprising memory means, processing means, display means and manual input means, wherein said memory means includes animation data comprising a plurality of attributes each having at least one keyframe and each keyframe having a time value and a plurality of cue points each having a time value, wherein a cue point is associated with one or more keyframes having the same time value, and changing the time value of a cue point changes the time values of its associated keyframes.

### BRIEF DESCRIPTION OF THE DRAWINGS

FIG. 1 shows a computer system for performing image processing;

FIG. 2 shows an application running on the computer system shown in FIG. 1;

FIG. 3 details a computer shown in FIG. 1;

FIG. 4 summarizes user operations for initializing the computer shown in FIG. 1;

FIG. 5 details the contents of the memory shown in FIG. 3 subsequent to the performance of steps shown in FIG. 4;

FIG. 6 details steps carried out in FIG. 4 to run an application;

FIG. 7 illustrates image data being processed by the application shown in FIG. 2;

FIG. 8 details steps carried in FIG. 6 to set cue points;

FIG. 9 shows a timeline used by the application shown in FIG. 2;

FIG. 10 shows cue point data shown in FIG. 5;

FIG. 11 shows envisaged project data;

FIG. 12 shows attribute data shown in FIG. 5;

FIG. 13 details steps carried out during FIG. 6 to create the animation data shown in FIG. 12;

FIG. 14 details steps carried out in FIG. 13 to set keyframes;

FIG. 15 details steps carried out in FIG. 14 to create keyframes;

FIG. 16 details steps carried out in FIG. 13 to edit keyframes;

FIG. 17 details steps carried out in FIG. 16 to dissociate keyframes from cue points;

FIG. 18 details steps carried out in FIG. 16 to snap keyframes to cue points;

FIG. 19 shows the timeline illustrated in FIG. 9 subsequent to the completion of steps shown in FIG. 18;

FIG. 20 illustrates an animation curve of an attribute shown in FIG. 19;

FIG. 21 shows cue points data shown in FIG. 10 subsequent to the completion of steps shown in FIG. 18;

FIG. 22 details steps carried out in FIG. 6 to move cue points;

FIG. 23 shows the timeline shown in FIG. 19 subsequent to the completion of steps shown in FIG. 22; and

FIG. 24 shows the animation curve shown in FIG. 20 after the steps carried out in FIG. 22.

### DETAILED DESCRIPTION

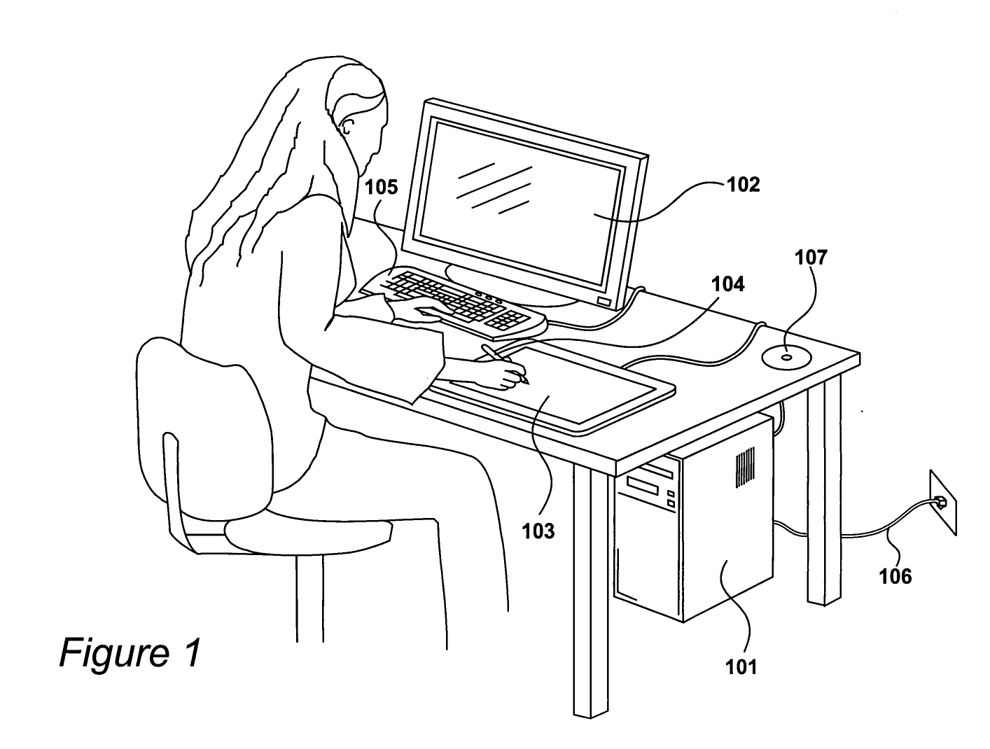

FIG. 1

An example of a computer system for performing image processing is shown in FIG. 1. A computer or processing system 101 stores and processes image data which is displayed on a display means, such as monitor 102. Operator input is supplied via a graphics tablet 103 with stylus 104, and a keyboard 105, although alternative manual input means could be used, for example a mouse or a trackball. Image data can be received and transmitted from the processing system 101 over a network 106. Instructions for the processing system 101, in the form of a program, can be loaded from a CD-ROM disk 107.

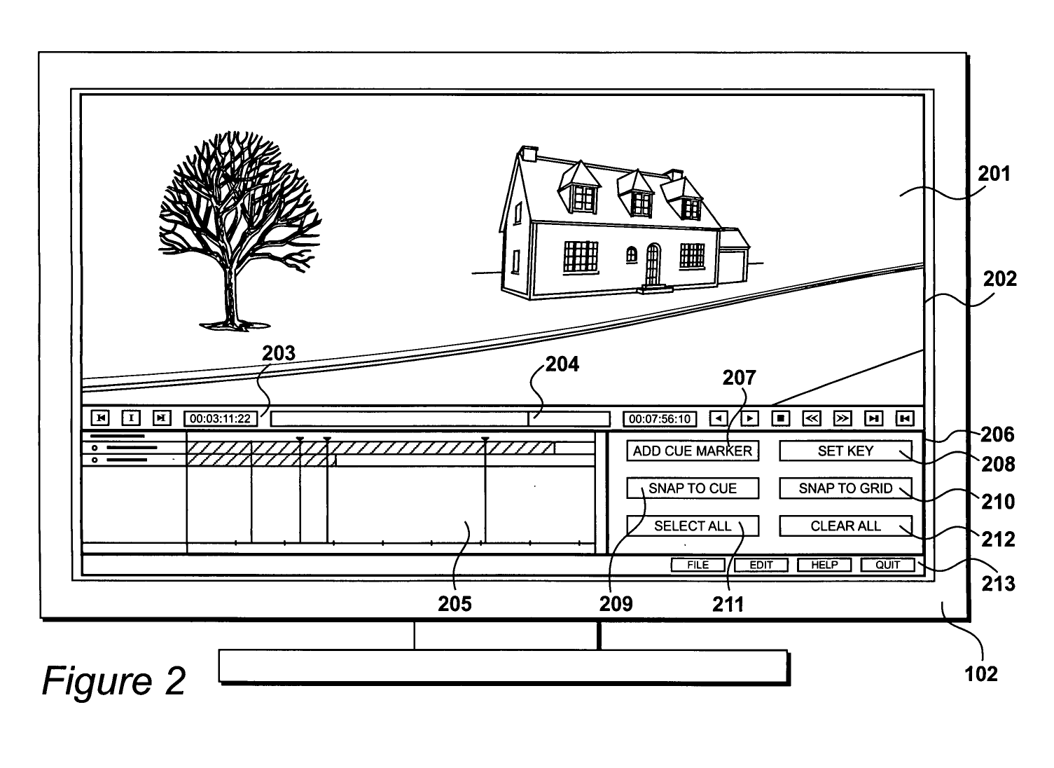

FIG. 2

A view of the application running on computer 101 as displayed on monitor 102 is shown in FIG. 2. The interface 201 includes a viewer 202 that shows the images currently being edited. Navigation controls 203 include a time indicator 204 that shows the time associated with the image currently displayed in viewer 202.

The interface also includes an editing and animation timeline 205 that is used to view and edit the various elements shown in viewer 202. These elements may be video or audio footage or computer-generated 2-D or 3-D objects. The interface 201 also includes a tool set 206 giving functionality for the timeline, including “ADD CUE MARKER” button 207 for adding cue markers, “SET KEY” button 208 for setting keyframes, “SNAP TO CUE” button 209 and “SNAP TO GRID” button 210 for easy placement of keyframes, “SELECT ALL” or “MARK ALL” button 211 for selecting/marking all attributes in timeline 205 and “CLEAR ALL” button 212 to clear all such selections/markings. Taskbar 213 provides buttons for file management functions.

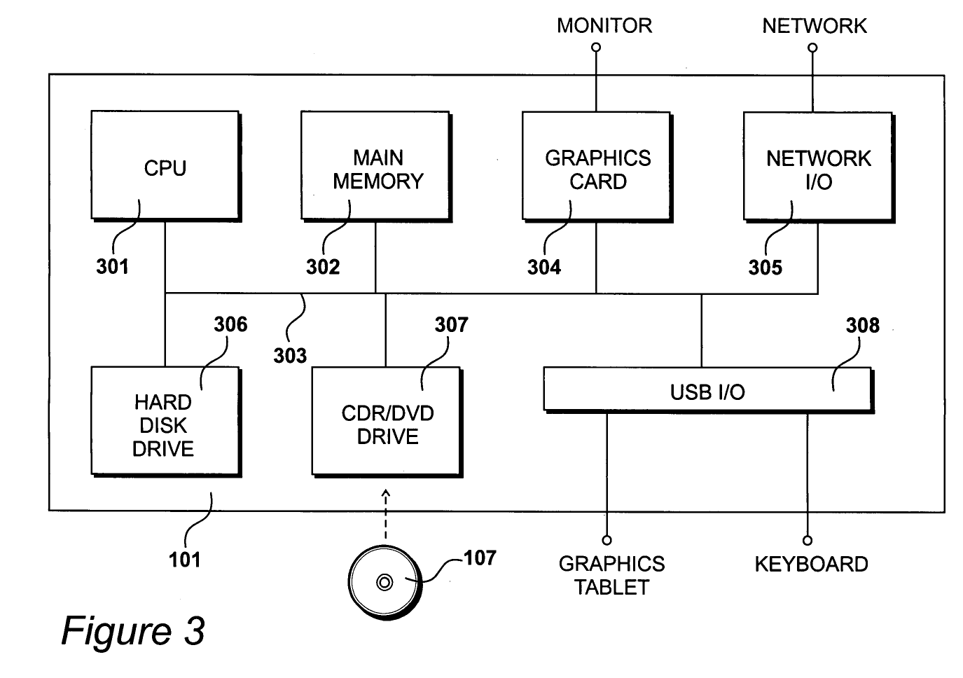

FIG. 3

The computer 101 shown in FIG. 1 is detailed in FIG. 3. In this example processing means is provided by a Pentium™ IV central processing unit (CPU) 301 that receives processing instructions from memory means, in this example main memory 302 that comprises five hundred and twelve megabytes (MB) of random access dynamic memory (RAM). Processing performed by the processor 301 acts upon data stored in the main memory 302 and data is transferred to and from other system components along several system buses 303. A graphics card 304 receives instructions and data generated by the processor 301 to generate image frames that are displayed upon the monitor 102, or a reduced aspect ratio monitor. A network input/output (I/O) card 305 provides communication with other processing systems connected to the network 106, and also to external networks including the Internet. Instructions and data can both be transferred via the network I/O card 305.

A hard disk drive 306 provides non-volatile local storage of instructions and data for the processing system 101. During operation of the processing system 101, instructions and data are transferred to the main memory 302 from which repeated processing transfers can be performed at high speed. Instructions and data can be supplied to or from the network 106, or from a CD-ROM disk 107. A CD-R/DVD drive 307 accepts CD-ROM disks, from which application processing instructions can be installed onto the hard disk drive 306, or possibly onto a remote application server on the network 106. A universal serial bus (USB) I/O circuit 308 provides connectivity between the processing system 101 and the graphics tablet 103, and the keyboard 105. Input signals from these devices are interpreted according to instructions running on the processor 301, resulting in appropriate selection of image processing operations being performed upon various data.

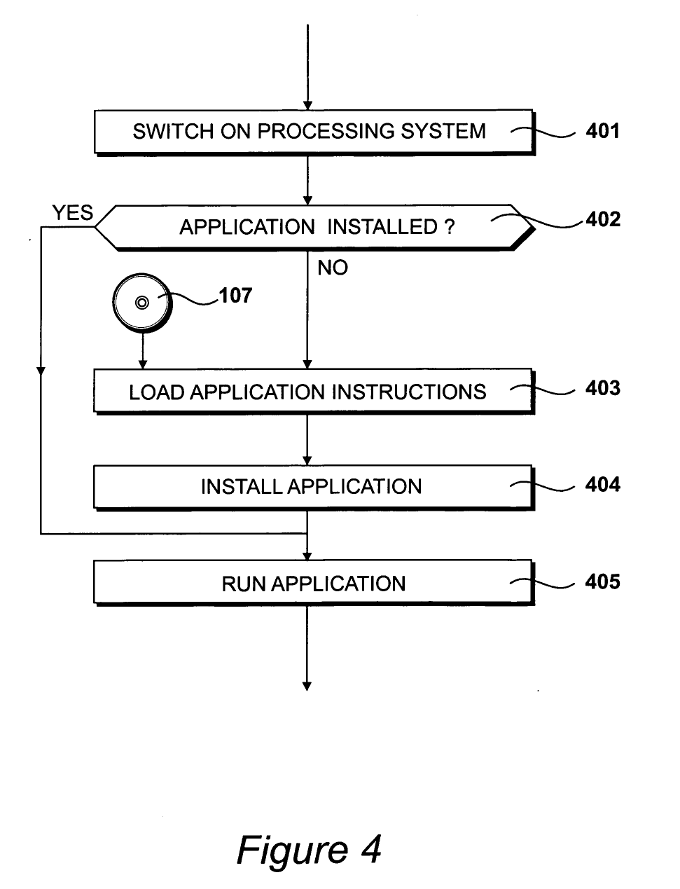

FIG. 4

User operations for initializing the computer 101 shown in FIG. 1 are summarized in FIG. 4. At step 401 the computer 101 is switched on. At step 402 a question is asked as to whether the image processing application is installed. If the application is already installed, control is directed to step 405. If the application does need to be installed, control is directed to step 403 where the image processing application is loaded from the CD-ROM disk 107. At step 404, the application is installed by running installation instructions. At step 405 the application instructions are run, and the user interacts with the application instructions by navigating the interface shown on the monitor 102 using the graphics tablet 103.

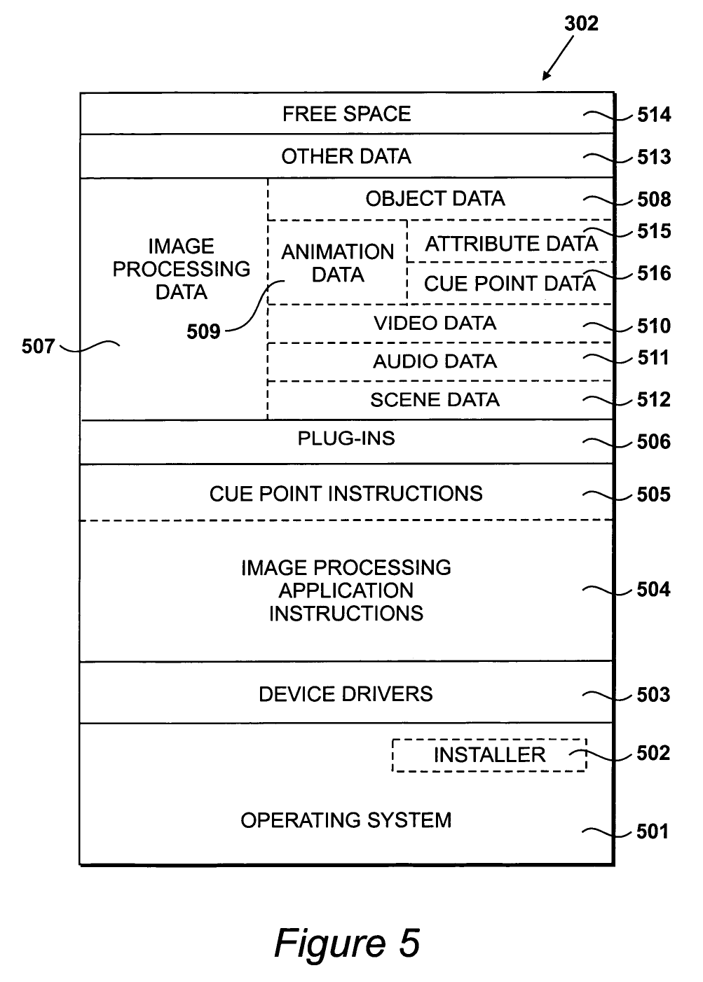

FIG. 5

The contents of the main memory 302 shown in FIG. 3 as a result of running the application are as detailed in FIG. 5. An operating system 501 provides processor instructions for common functionality, such as the ability to allocate portions of main memory 302 in response to the demands of application processes. The operating system 501 is a Windows™ NT 4.0 operating system, although alternatives including the Linux™ operating system are increasingly used in image processing workstations. The operating system 501 includes installation instructions 502 for installing the image processing application, or other applications, onto the hard disk drive 306. Device driver instructions 503 provide hardware abstraction for the operating system 501, so that operating system processing instructions can be executed in the same way on workstations of widely varying hardware.

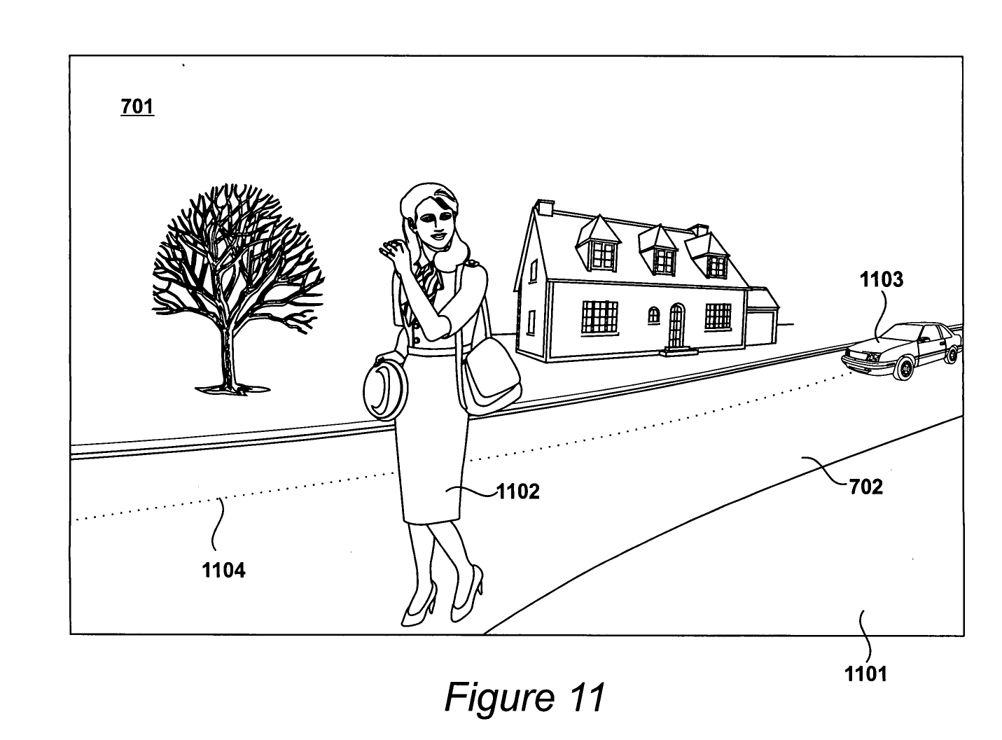

Image processing application instructions 504, having commenced execution at step 405 in FIG. 4, reside in main memory 302 so as to facilitate user-intended image processing operations upon image data. Image processing instructions include cue point instructions 505, so that user-directed activation of the interface will result in steps being performed such as those detailed in FIGS. 11 to 16.

Plug-ins 506 provide some of the functionality used by the image processing application instructions 504. Typically, image processing operations upon image data are performed by instructions provided as part of the main image processing application instructions 504 or as one of several plug-ins 506. Image processing application data 507 stores the image data upon which some form of processing is being performed. It includes object data 508, animation data 509, video data 510, audio data 511 and scene data 512.

Object data 508 includes two-dimensional and three-dimensional models, characters, lights and so on, all of which may be animated by applying animation data 509 to them. The objects and their animation data 509 are closely bound together. Animation data 509 in turn includes attribute data 515 and cue point data 516. Attribute data 515 includes keyframes information for each animated attribute of each object, while cue point data 516 includes information on cue points that are used to tie together attributes in order to group them and move them together in time. Video data 510 comprises clips of frames and audio data 511 comprises sound files. Scene data 512 includes data structures that define the way in which the animated objects, video data and audio data interact in order to create the required images. It is typically represented as a hierarchical node-structure.

Other data 513 used by the processing system includes data structures used by the operating system. Free space 514 varies significantly in response to varying processing demands made in response to user operations and also by calls made to the operating system by the application that result in allocation or freeing of main memory portions.

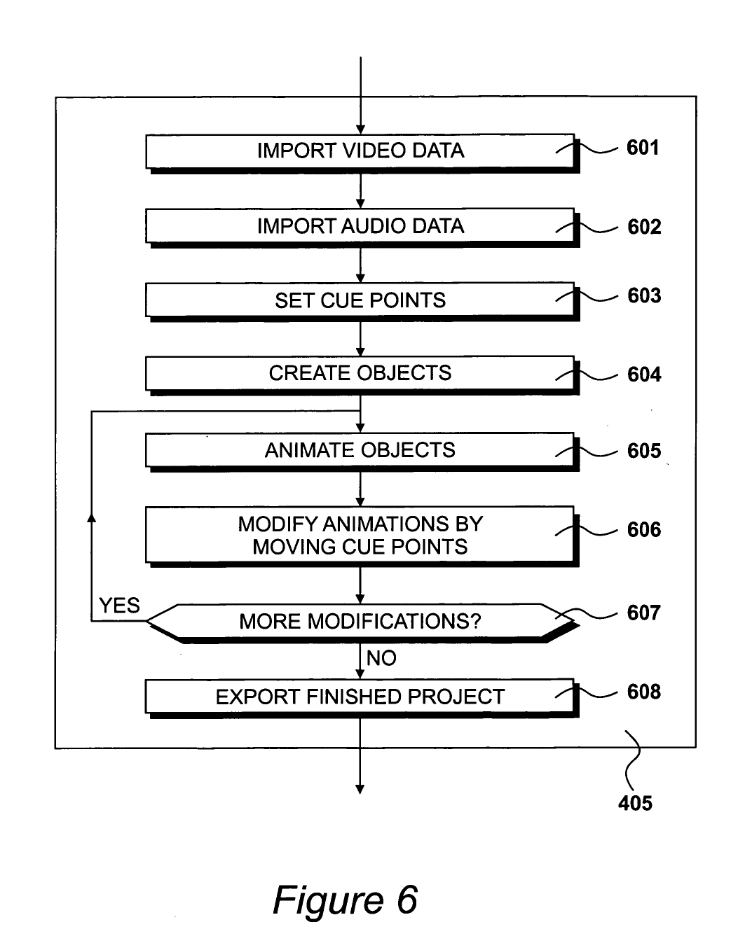

FIG. 6

FIG. 6 details step 405 at which the application is run. At step 601 the video data required is imported and at step 602 the audio data required is imported. At step 603 the video data, and possibly also the audio data, is viewed and cue points are set that define points in the video data where certain animations are to occur. Typically, this process may be carried out by the director of the project, which could be a film, a music video, an advert and so on, and the required animations could be anything from the appearance of a cartoon character to the point at which a sophisticated animated explosion should occur.

At step 604 the objects to be animated are created and at step 605 they have animations added to them, keyframes in said animations being associated with the cue points where appropriate. At step 606 the animations are modified if necessary by moving the cue points. These modifications will probably be made by the director on viewing the preliminary results and deciding that one or more of the animations should be moved in time. This can be easily achieved by simply moving one or more of the cue points which will also move the keyframes associated with the cue points.

The director will probably also request that other modifications be made to the objects themselves or to the way in which they are animated and so at step 607 a question is asked as to whether there are any more modifications to be made to the animation and if this question is answered in the affirmative the control is returned to step 605 for more sophisticated modifications to be carried out by the artist, after which the director can again move the cue points if necessary at step 606.

Eventually the question asked at step 607 will be answered in the negative to the effect that there are no more modifications to be made and at step 608 the finished product is exported.

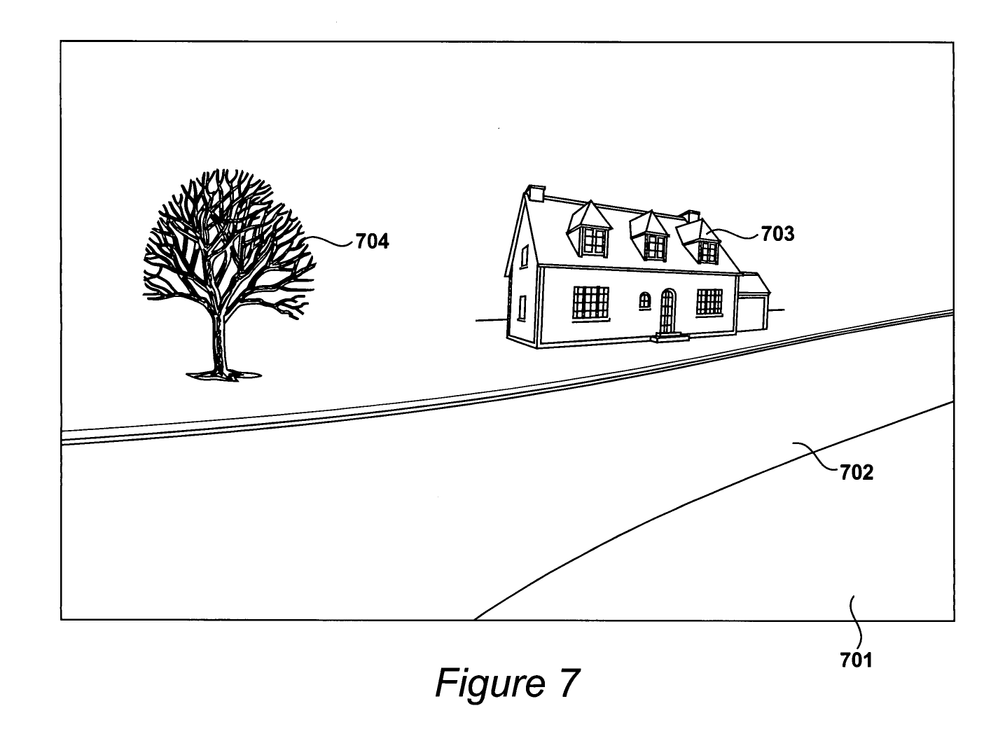

FIG. 7

FIG. 7 shows the project being created, as shown in viewer 202 on interface 201. Currently it comprises only background image 701, which is an example of video data 510 and comprises a scene showing a road 702, a house 703 and a tree 704. Although it is of necessity shown as a still image, it is in fact moving and panning down the road from right to left. Thus it is necessary for any animated objects that are to be added to move relative to this panning of the camera.

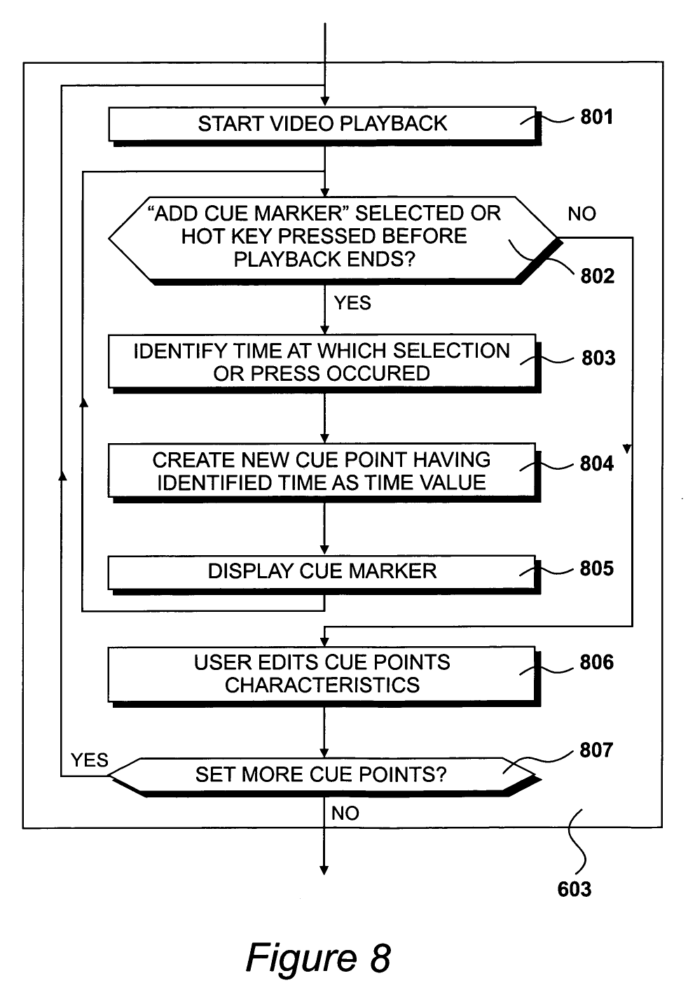

FIG. 8

FIG. 8 details step 603 at which cue points are set. At step 801 playback of the data loaded so far, which in this example is background image 701/video data 510, is initiated using the navigation controls 203. Any loaded audio data may also be played or may be muted. At step 802 a question is asked as to whether a cue point has been assigned by the pressing of button 207 in interface 201 using stylus 104 or by the pressing of a “hotkey” on keyboard 105. If either of these occurs then the question is answered in the affirmative and the time at which this selection or key press occurred is identified at step 803.

At step 804 a new cue point is created at the identified time and at step 805 a cue marker for the new cue point is displayed on timeline 205. Control is then returned to step 802 to wait for another button selection or key press.

More cue points may be added, or alternatively if the playback finishes or is stopped the question asked at step 802 is answered in the negative and control is directed to step 806 at which characteristics of the new cue points, in particular their names and the times at which they occur, can be edited.

At step 807 a question is asked as to whether more cue points are to be set and if this question is answered in the affirmative then control is returned to step 801 and playback is initiated once more. Alternatively, if it is answered in the negative step 603 is concluded.

Thus this method eliminates the need to stop the tape, work out exactly when the animation is required and write down the frame number. Instead a key is pressed at precisely the right moment and the artist does not need to write anything down.

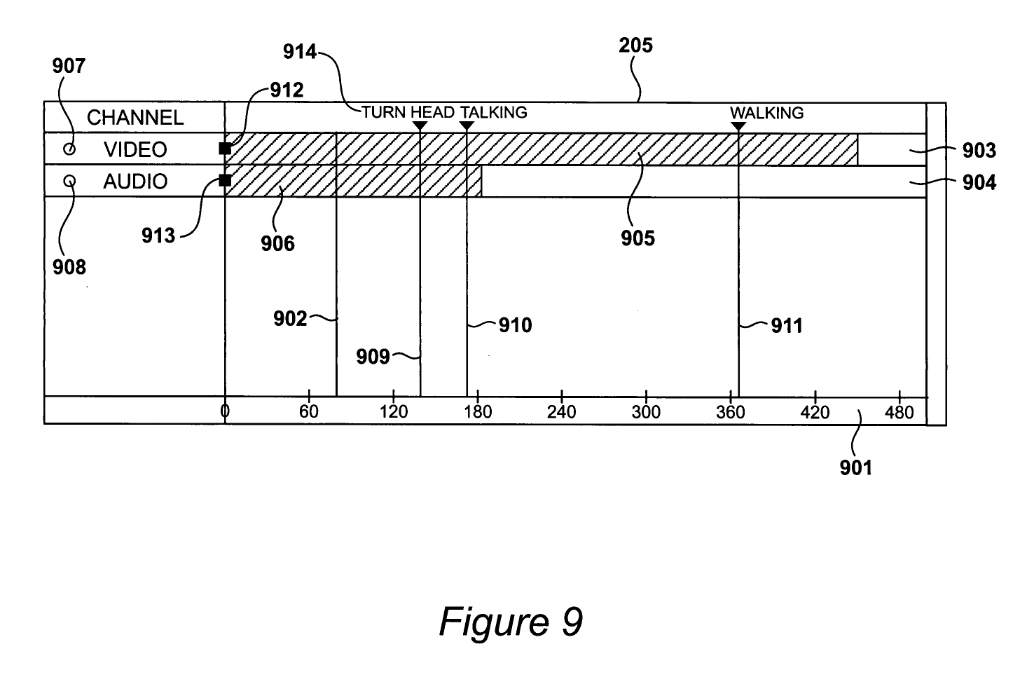

FIG. 9

FIG. 9 shows timeline 205 after step 603, when video data and audio data have been imported and cue points have been added. It includes a frame counter 901 and a time marker 902. This marker does not correspond to the display of background image 701/image data 510 in viewer 202—time relative to the viewer 202 is shown by time indicator 204—but is used to control the time at which changes should be applied to an animation. Image data 510 (e.g., background image 701) and the loaded audio data are shown at channels 903 and 904, with the shading 905 and 906 indicating the actual placement of the footage. Radar buttons 907 and 908 provide a method of marking a channel to indicate that work is to be carried out upon it. It will be noted that the audio data has not yet been placed correctly but simply imported. Keyframe markers 912 and 913 for the video data in channel 903 and the audio data in channel 904 respectively show when playback of each data is to start.

Three cue markers 909, 910 and 911 have been added by the director at step 603. The project is to be an advertisement with an animated character and an animated car against real video footage. The scene is to start with a lady walking along the road. At the time indicated by cue marker 909 she is to turn her head towards the camera and the car is to appear and drive down the road, and at the time indicated by cue marker 910 she is to stop walking, raise her hand to her hair and start talking. At the time indicated by cue marker 911, after she has stopped talking, the character is to start walking again and the scene will end. The names of the cue points are displayed next to the markers to aid the artist, for example the name “TURN HEAD” is shown at 914 adjacent to cue marker 909.

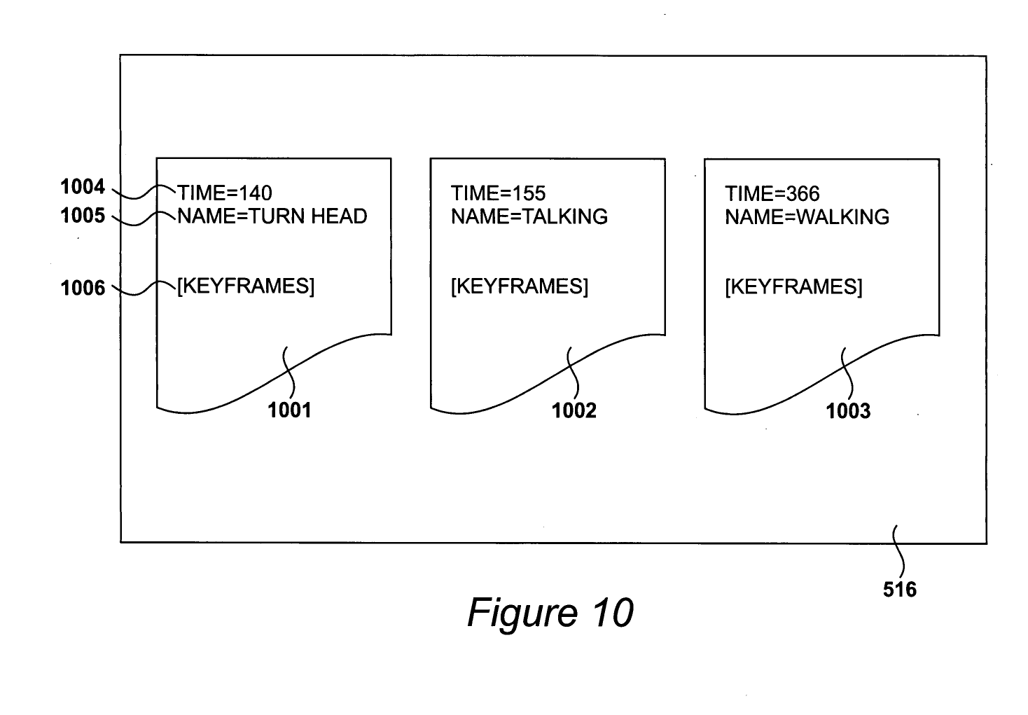

FIG. 10

FIG. 10 shows cue point data 516 including cue points 1001, 1002 and 1003. Cue points 1001 to 1003 are the data underlying cue markers 909 to 911 respectively and contain name, time and keyframe information about each one. For example, cue point 1001 includes line 1004 at which the time of the cue point is given as 140, that is 140 frames after the beginning of the image data, and line 1005 at which its name is given, which in this example is “TURN HEAD”. When created this cue point will have been given the name “CUE ONE” but it can be renamed at any time with a name indicating the animation which is to occur at this cue point.

Line 1006 indicates the start of a list of keyframes that are associated with the cue point, but as yet no keyframes have been associated with the cue points.

FIG. 11

FIG. 11 shows the completed project data 1101 at the end of step 605, which consists of the background image 701 (e.g., video footage 510) and the audio data in channel 904 along with two animated objects, the first being a female character 1102 and the second a 3-D model of a car 1103. The step 604 of creating these objects will not be described in detail here since there are many ways of performing this task dependent upon the object created. However, each object is actually a product of a mass of attributes applied to a large number of different but related objects. For example, character 1102 consists of a plurality of bones, each of which has movement attributes, either relative to the world as seen in the viewer 202 or relative to other bones in the character. It also has skin mesh, clothes and hair that have positioning, shading and color and so on. An object such as character 1102 has hundreds of attributes. When an object is created each attribute is entered in a channel in timeline 205. Broadly speaking, the process of creating an object comprises creating its attributes, and the process of animating a character comprises giving parameter values at specific times to these attributes.

For example, line 1104 shows the path that car 1103 is to take. This is an attribute of the car. As an example of how animations can be created in different ways, this path is saved and loaded as a pre-determined motion path and the car is constrained to follow it. The parameter value at any time determines only the speed at which the car follows the path. Conversely, the path that character 1102 takes and also the speed at which she walks is determined by attributes giving the positional data of each of her feet.

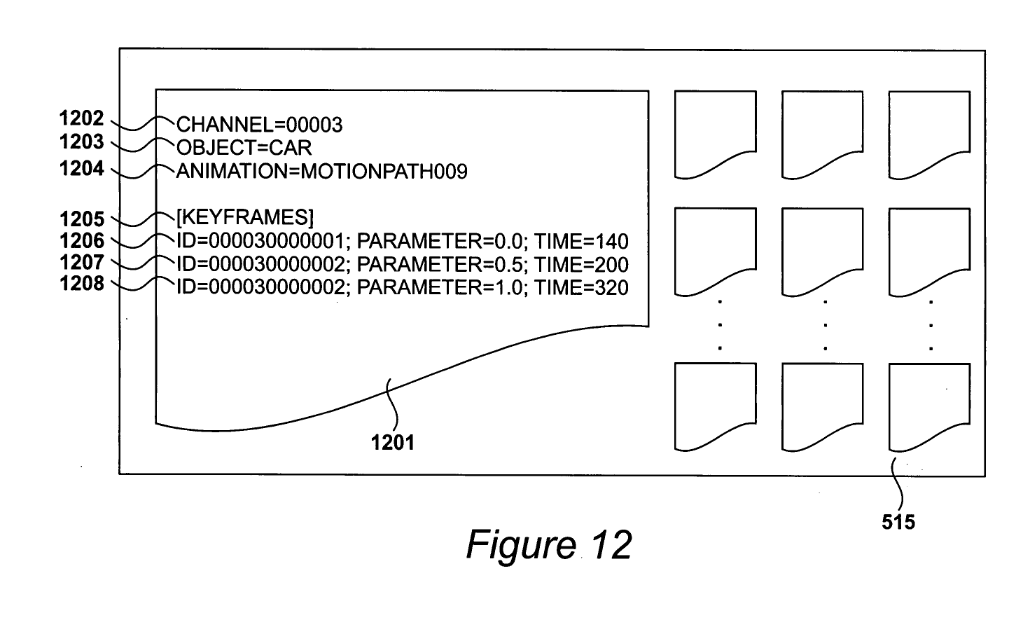

FIG. 12

FIG. 12 shows attribute data 515. Every attribute for the objects in project data 1101 is contained here. Each attribute is made up of keyframes. A keyframe is data containing a specific parameter value for the attribute at a specific point in time, called its time value. The nature of the parameter value depends on the nature of the attribute. Rotational data is usually a single number; positional data could be a three-dimensional array while color data could be a four-dimensional array. Alternatively, for example, positional data could be provided by three separate single-entry attributes.

Attributes typically have a large number of keyframes but a much larger number of “in-between” frames, where the parameter value of the attribute at a particular frame is calculated using some form of interpolation between the adjacent keyframes, thus creating an animation curve. Altering either the parameter value or the time value of any keyframe modifies the animation curve for that attribute, and thus changes the animation of the object.

In this example, attribute 1201 is the attribute giving the motion of the car along path 1104. Line 1202 gives the channel in which the attribute is stored and line 1203 indicates that the object to which the animation applies is the car. As previously described this is a pre-determined path that is stored in objects data 508 and referred to here at line 1204.

Line 1205 indicates the start of keyframes information. Line 1206 indicates the first keyframe, which has a time value of 140 and a parameter value of 0.0. This indicates that the object, in this case the car, is to be at the beginning of the motion path at 140 frames. Line 1207 indicates the second keyframe, which has a time value of 200 and a parameter value of 0.5. This indicates that at frame 200 the object must be at the halfway point of the motion path. In-betweening will mean that the object travel along the first half of the motion path between frames 141 and 199. Similarly, line 1208 shows that by frame 320 the object must be at the end of the motion path. This means that the object has sixty frames in which to travel the first half of the path but one hundred and twenty frames in which to travel the second half of the path, indicating that at frame 200 the car will immediately halve its speed. Adding in more keyframes would give a smoother result.

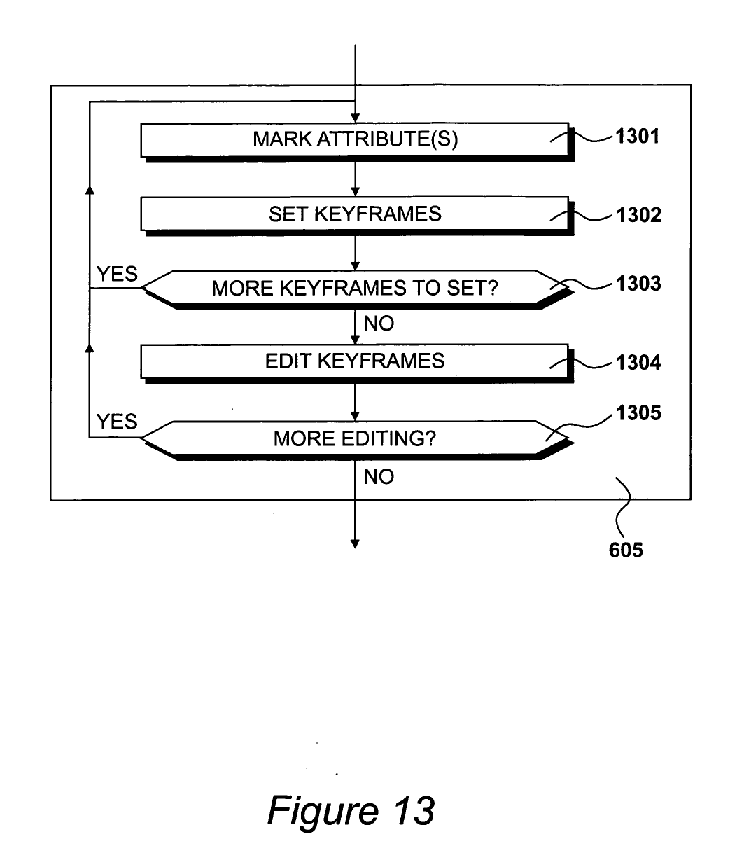

FIG. 13

FIG. 13 details step 605 at which the animation data 509 (e.g., attribute data 515) as shown in FIG. 12 is created; the objects created at step 604 are animated by setting keyframes for their attributes. At step 1301 attributes for which keyframes are to be set are selected by marking their radar buttons on timeline 205. At step 1302 keyframes are set for these marked attributes and at step 1303 a question is asked as to whether there are more keyframes to be set. If this question is answered in the affirmative then control is returned to step 1301 and more attributes are marked. If it is answered in the negative then at step 1304 the new keyframes are edited.

At step 1305 a question is asked as to whether the editing is complete and if this question is answered in the negative then control is returned to step 1301 to set more keyframes. If it is answered in the affirmative then step 605 is complete and the project data 1101 is ready for a first viewing by the director.

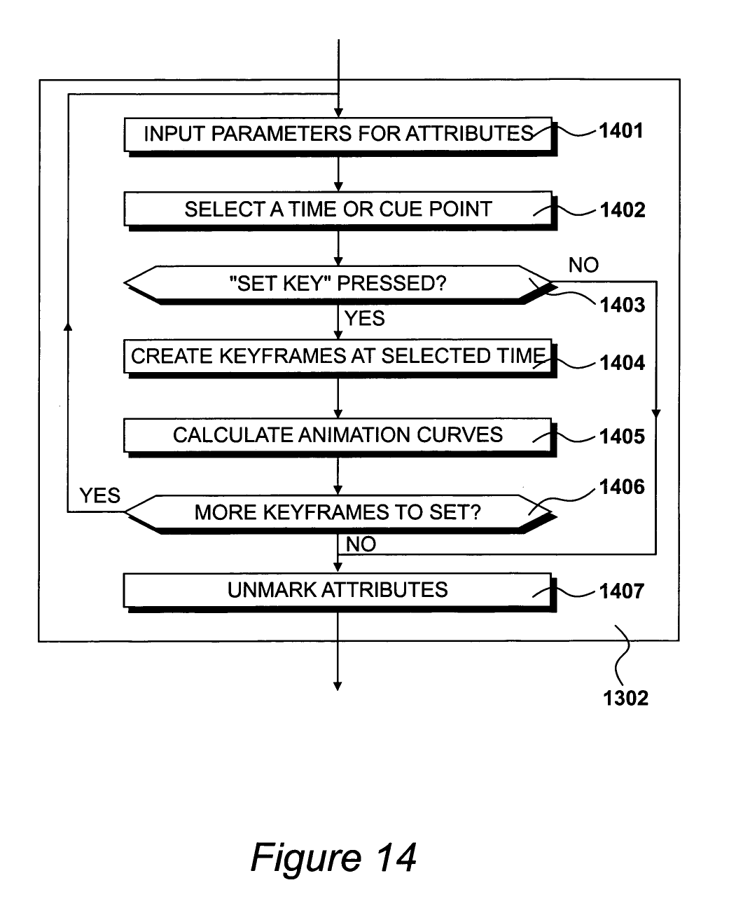

FIG. 14

FIG. 14 details step 1302 at which keyframes are set. At step 1401 parameters are input, if necessary, for each of the marked attributes. This can be achieved either by inputting a value into a dialog box or by dragging the object to the required position, for example moving the car 1103 to a position on its motion path or moving character 1102's hand up to her hair. Alternatively, if the already-defined animation for an attribute is acceptable but the user wishes to create a keyframe in order to tie the attribute to a cue point then no parameter value is input.

At step 1402 a time in frames is selected, either by moving time marker 902 to a particular point or by selecting a cue marker. During this process, the selection of a cue marker overrides the position of time marker 902.

At step 1403 a question is asked as to whether button 208, marked “SET KEY”, has been selected. If this question is answered in the affirmative then at step 1404 keyframes are created at the specified time for the marked attributes.

At step 1405 the new animation curves for the marked attributes are calculated and at step 1406 a question is asked as to whether more keyframes are to be set for the marked attributes. This question is answered in the negative, as is the question asked at step 1403, by a selection of button 212 in interface 201, marked “CLEAR ALL”. In these cases control is directed to step 1407 where the marked attributes are unmarked and step 1302 is completed. Alternatively, any other input answers the question asked at step 1406 in the affirmative, control is returned to step 1401 and more parameters are input for the selected attributes.

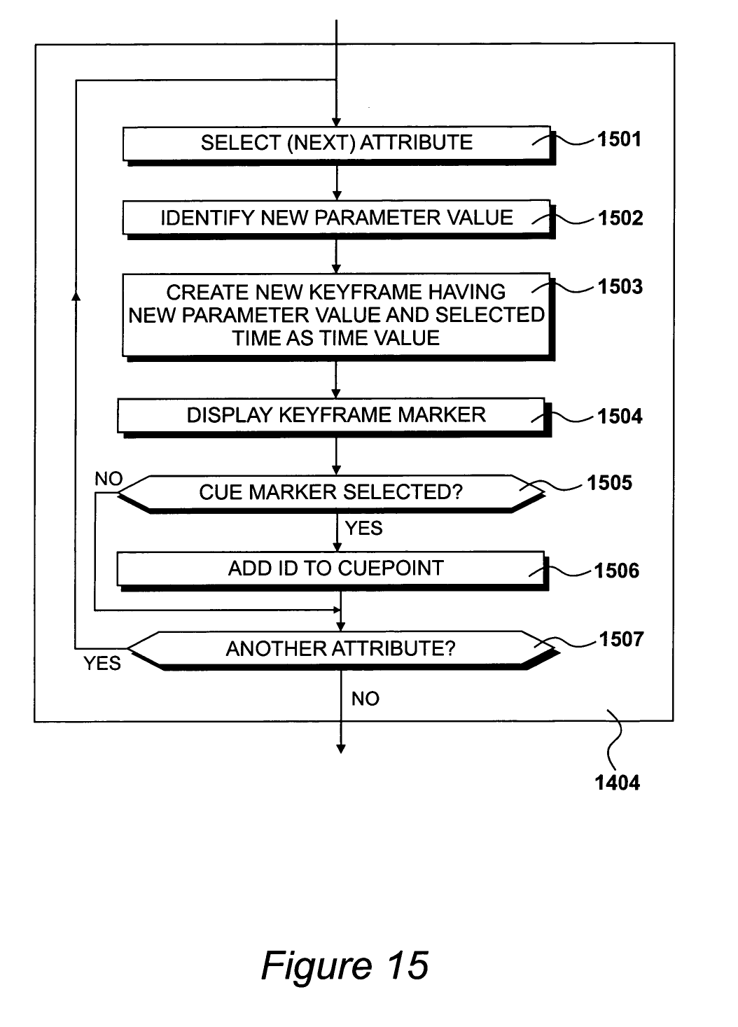

FIG. 15

FIG. 15 details step 1404 at which keyframes are created for the selected time. At step 1501 the first of the marked attributes is selected and at step 1502 the parameter value for this attribute is identified. If the attribute has been selected but no parameter value has been input, the identified value is the interpolated value for that attribute at the selected time, as given by the animation curve.

At step 1503 a new keyframe is created for this attribute, having the identified parameter value and having the time selected at step 1402 as its time value (if a cue marker was selected then it is the time value of the underlying cue point). At step 1504 a marker for this keyframe is displayed.

At step 1505 a question is asked as to whether a cue marker was selected at step 1402. If this question is answered in the affirmative then at step 1506 the ID for this new keyframe is added to the cue point that corresponds to the selected cue marker. At this point, and if the question asked at step 1505 is answered in the negative, then another question is asked at step 1507 as to whether there is another marked attribute. If this question is answered in the affirmative then control is returned to step 1501 and the next attribute is selected. If it is answered in the negative then step 1404 is concluded.

Thus if a cue point is selected when button 208 is pressed, keyframes are set and associated with that cue point.

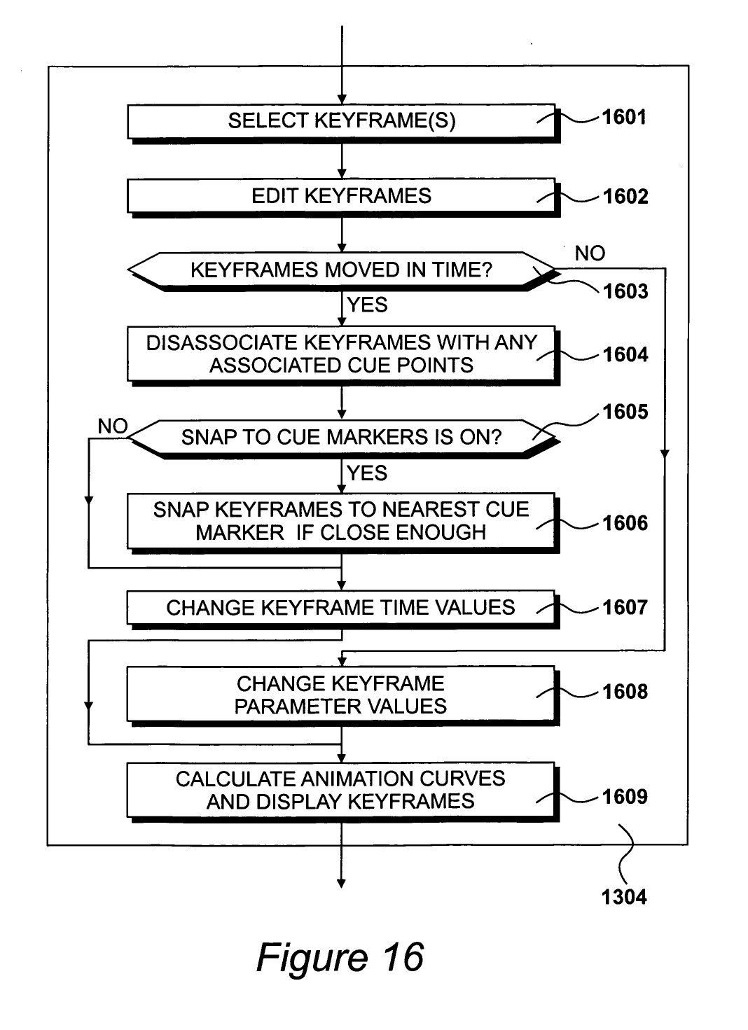

FIG. 16

FIG. 16 details step 1304 at which keyframes are edited. There are various characteristics of keyframes that can be changed, depending upon the type of animation, but this description concentrates on changing the time value or changing the parameter value.

At step 1601 at least one keyframe is selected and at step 1602 a change is input by the user. At step 1603 a question is asked as to whether this change is a movement in time and if this question is answered in the affirmative the keyframes are first dissociated from any cue points they are currently associated with at step 1604. This is because moving a keyframe away from a cue point breaks its association with the cue point.

At step 1605 a question is asked as to whether the function “snap to cue point/makers” is on. This is turned on or off by selecting button 209 in interface 201. If this question is answered in the affirmative then at step 1606 the moved keyframes are moved to the time of and associated with their nearest cue points, if those cue points are near enough. At step 1607 the time values for the keyframes are updated.

If the question asked at step 1603 is answered in the negative, to the effect that the input at step 1602 is not a movement in time, then the input was a change in parameter values and so control is directed to step 1608 where the parameter values are changed in line with the input.

Following both step 1607 and step 1608 control is directed to step 1609 where the animation curves for the attributes that have changed keyframes are calculated, and the changed keyframes are displayed.

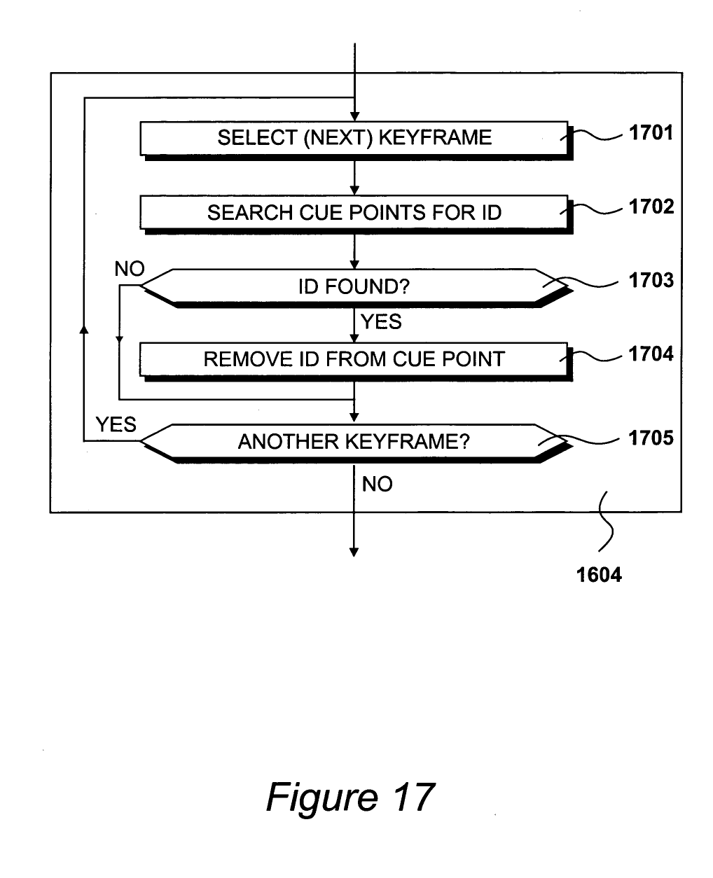

FIG. 17

FIG. 17 details step 1604 at which keyframes that are moved through time are dissociated from their cue points. At step 1701 the first moved keyframe is selected and at step 1702 its ID is searched for in the cue point data 516. At step 1703 a question is asked as to whether it has been found and if this question is answered in the affirmative then the ID is removed from the cue point at step 1704. At this point, and if the question asked at step 1703 is answered in the negative, another question is asked at step 1705 as to whether there is another moved keyframe. If this question is answered in the affirmative then control is returned to step 1701 and the next keyframe is selected. If it is answered in the negative then step 1604 is concluded.

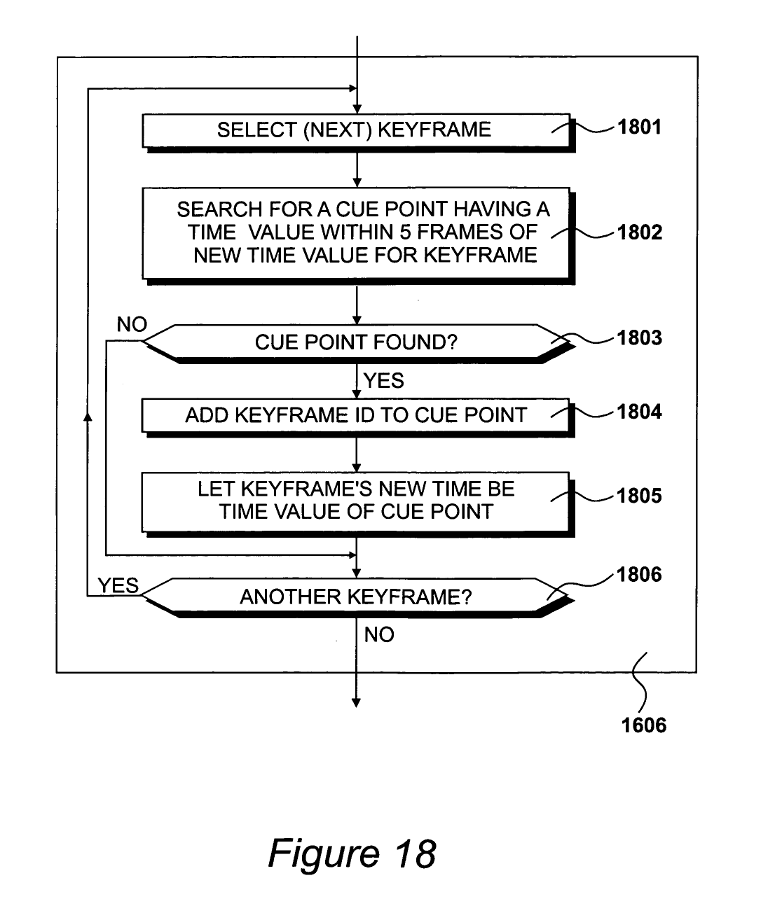

FIG. 18

FIG. 18 details step 1606 at which keyframes are ‘snapped’ to cue points if this function is turned on. At step 1801 the first keyframe is selected and at step 1802 a cue point having a time value within a specified number of frames, which in this example is five, of the new time value that the keyframe has been moved to. At step 1803, a question is asked as to whether the cue point has been found. If this question is answered in the affirmative then the keyframe ID is added to this cue point at step 1804 and the keyframe is moved again to the time value of the cue point at step 1805.

Following this, and if the question asked at step 1803 is answered in the negative, to the effect that there is no cue point near enough to the keyframe's new time, then a question is asked at step 1806 as to whether there is another keyframe to consider. If this question is answered in the affirmative then control is returned to step 1801 and the next keyframe is selected. If it is answered in the negative then step 1606 is concluded.

Thus, if there is a cue point within a specified number of frames of a keyframe's new time then that new time is set to be the time value of the cue point. This is the time that is then set to be the keyframe's time value at step 1607.

It will be clear to persons skilled in the art that at any point during the creation or modification of animations, new cue points can be created, old ones can be deleted (this does not delete the associated keyframes), and keyframes can be deleted (this removes any association from a cue point). Additionally, cue point data 516 can be searched, for example using scripts, for all attributes having keyframes associated with a particular cue point, and so cue points can also be used to quickly tie together groups of attributes without creating links or expressions. Alternatively, a portion of a keyframe ID could be searched for to find all the cue points associated with a particular attribute, and so on.

The skilled person will also understand that animation is not limited to objects such as car 1103 and character 1102. Anything in the application can be animated. For example, the shape of a garbage mask, the color, position and brightness of lights, transforms, tool attributes and so on can all be considered as an attribute, have keyframes set and be animated, and can thus be associated with cue points. For example, the video data in channel 903 is actually an animation that retrieves background image 701 and plays it from a certain time and at a certain speed, as set by its keyframes.

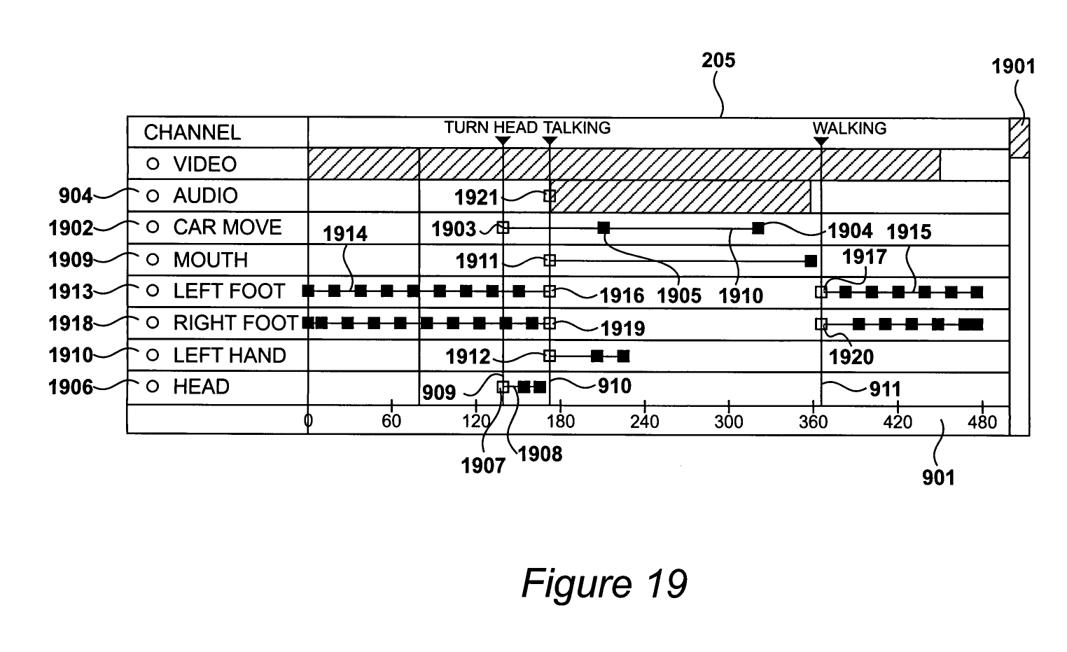

FIG. 19

FIG. 19 shows timeline 205 at the end of step 605 when the objects have been animated. The image/project data 1101 is now suitable to be shown to the director. Although there would typically be hundreds if not thousands of attributes in a scene such as this, only a few can be shown at any one time. Scroll bar 1901 may be used to view the remaining attributes.

Each channel is shown in track view, where only the keyframes, shown as squares, and the length of the animation is shown. Parameter values are not given. For example, channel 1902 contains the attribute of the movement of the car, the data for which is shown at 1202. This starts at keyframe 1903, at frame 140, and ends at keyframe 1904, at frame 320. Keyframe 1905 is at frame 200. Keyframe 1903 is associated with cue marker 909, as shown by its unfilled marker, whereas keyframes 1904 and 1905 have black markers which are unassociated with cue markers. The fact that the attribute is animated between these keyframes is shown by line 1906 connecting them all.

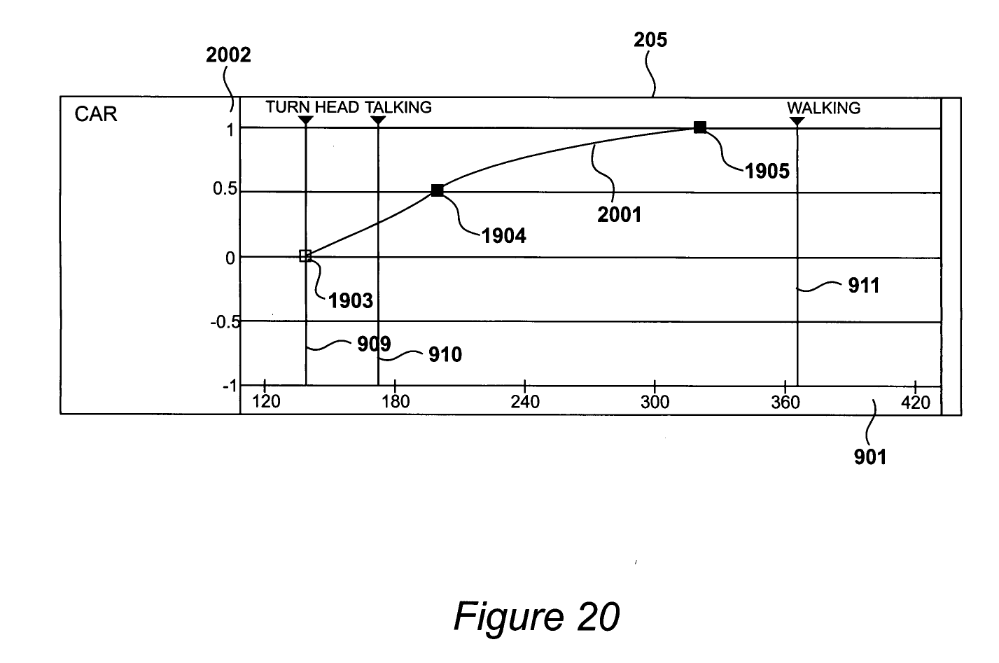

The parameter values at each keyframe can be seen, for example, by hovering the cursor over them, by clicking on them to bring up a dialog box, or by double clicking on the attribute to bring up an animation view of the attribute, as shown in FIG. 20.

Similarly to the car movement 1902, movement of the head attribute 1906 has the first keyframe 1907 in its animation 1908 associated with cue marker 909. The animation of the mouth attribute 1909, which follows a pre-determined animation that matches the voice data in channel 904, and the movement of the left hand attribute 1910 have their initial keyframes 1911 and 1912 respectively linked to cue marker 910. Left foot movement attribute 1913 has two separate animations 1914 and 1915. The final keyframe 1916 of the first animation 1914 is associated with cue marker 910, while the initial keyframe 1917 of the second animation 1915 is associated with cue marker 911. Similarly right foot attribute 1918 has one keyframe 1919 associated with cue marker 910 and another keyframe 1920 associated with cue marker 911.

Additionally, the audio data in channel 904 has a keyframe 1921 at the beginning of its playback. This is in order that it may be associated with cue marker 910.

Although in this example all the keyframes associated with cue points are at the beginning or end of an animation there is no need for this to be the case. Any keyframe of any attribute may be associated with a cue point.

FIG. 20

FIG. 20 shows the animation curve 2001 of car movement attribute 1902. Frame counter 901 and cue markers 909, 910 and 911 are still present, as are keyframes 1903, 1904 and 1905, but the parameter values of the keyframes are mapped against values axis 2002 instead of lying flat in a channel. Thus it can be seen that the parameter value is 0 at 140 frames at keyframe 1903, which is associated with cue marker 909, 0.5 at 200 frames and 1 at 320 frames. In this example the interpolation between keyframes that produces animation curve 2001 is a Bezier approximation but any other interpolation method could be used. At any frame the animation curve 2001 gives the position along motion path 1104 of car 1103.

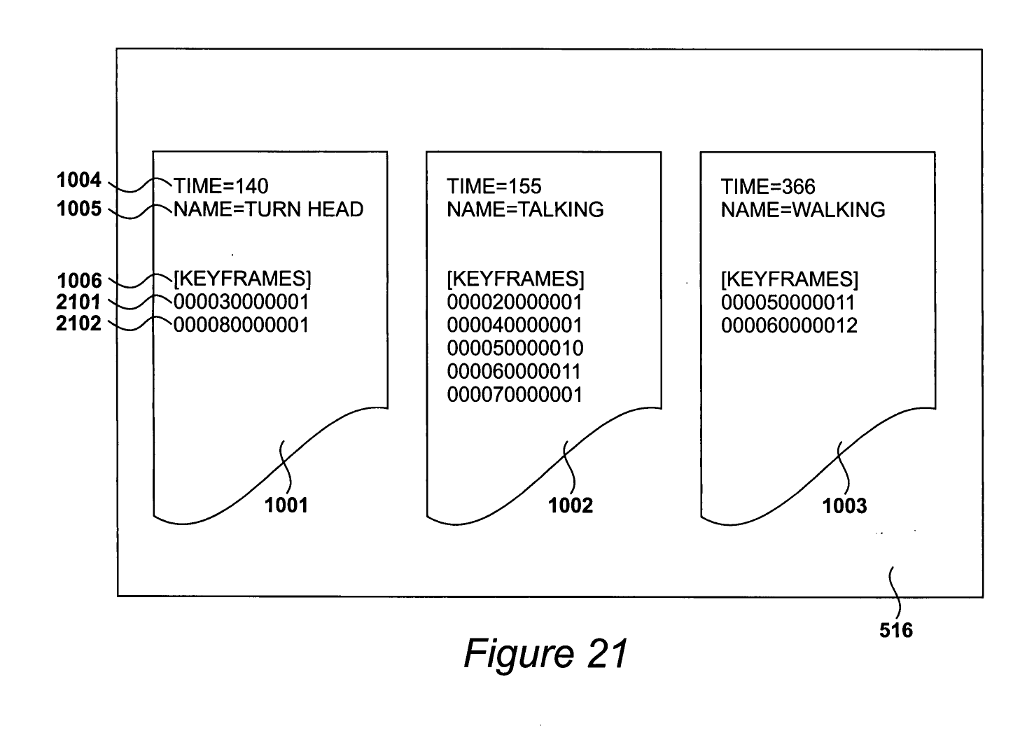

FIG. 21

FIG. 21 shows cue point data 516 that was shown in FIG. 10 after the cue points had been created but before any animation had been created. However the data shown in FIG. 21 is after the animation has been created.

As shown in FIG. 10, cue point 1001 has line 1004 giving its time value and line 1005 giving its name. It also now has two lines under keyframes data 1006. The first, at line 2101, is keyframe ID 000030000001, which refers to the first keyframe of the attribute in the third channel, that is to say keyframe 1903. The second, at line 2102, is keyframe ID 000080000001, which is the first keyframe of the attribute in the eighth channel, which is keyframe 1907. These are the two keyframes that are associated with cue point 1001, as represented by cue marker 909.

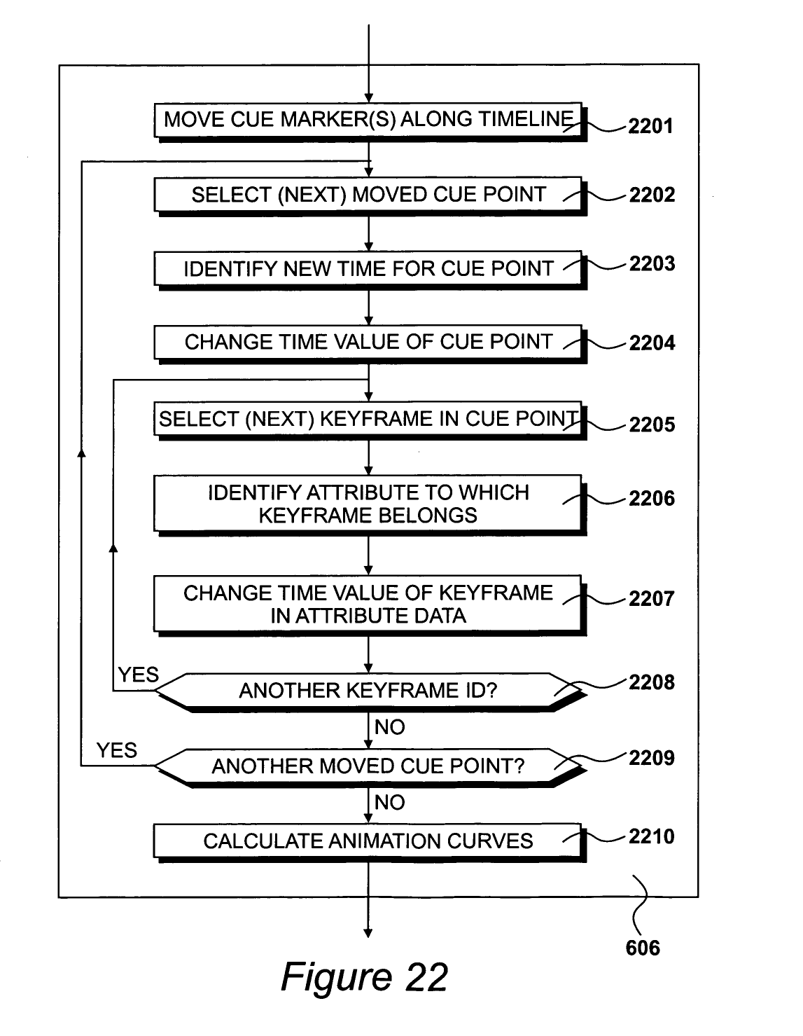

FIG. 22

FIG. 22 details step 606 at which animations are modified by moving cue points. In this example, although the artist has provided animations at precisely the points in the video data required by the director—since keyframes are associated with the director's own cue points this must be the case—the director on viewing the end result requires the animation to be moved. In particular, he wishes the car and the head turn to occur earlier. Cue point 1001 therefore needs to have an earlier time value which is accomplished by moving cue marker 909 to the left at step 2201.

More than one cue marker can be moved at once, and therefore at step 2202 the cue point corresponding to the first moved marker is selected. At step 2203 its new time is identified and at step 2204 the time value of the cue point is changed to be this new time.

At step 2205 the first keyframe ID in the cue point is selected and at step 2206 the attribute to which it belongs is identified by examining the ID. At step 2207 the time value of the keyframe is changed in the attribute's data. At step 2208 a question is asked as to whether there is another keyframe ID in the cue point and if this question is answered in the affirmative then control is returned to step 2205 and the next keyframe ID is selected.

If it is answered in the negative then at step 2209 a question is asked as to whether there is another moved cue marker. If this question is answered in the affirmative then control is returned to step 2202 and the next cue point is selected for processing in the same way.

If the question asked at step 2209 is answered in the negative then at step 2210 new animation curves are calculated for the changed attributes and step 606 is completed.

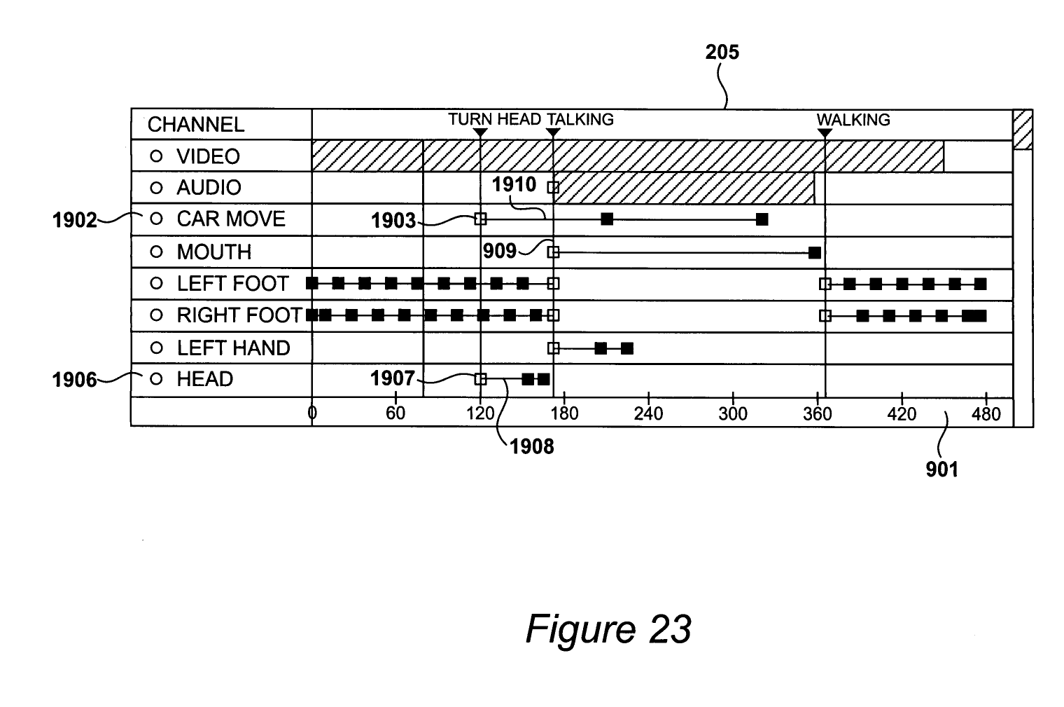

FIG. 23

FIG. 23 shows timeline 205 as shown in FIG. 19 after the cue point movement step 606. Cue marker 909 has been moved backwards twenty frames and keyframes 1903 and 1907 that are associated with the underlying cue point 1001 have moved with it. This has stretched the animation lines 1910 and 1908 of attributes 1902 and 1906. If the user does not wish the curves to be stretched then a modification key could be implemented that would drag all the keyframes along with the cue marker. Alternatively, more cue markers could be used and they could be moved all at once.

The skilled reader will understand that in a typical animation many hundreds or even thousands of attributes will be present and the ones required will not be handily situated in the top channels. Thus the process described herein provides a method of associating all the events that are to happen at a specific time with a cue point and moving all of them together should that be required, instead of laboriously searching through the attributes to find the ones that need changing.

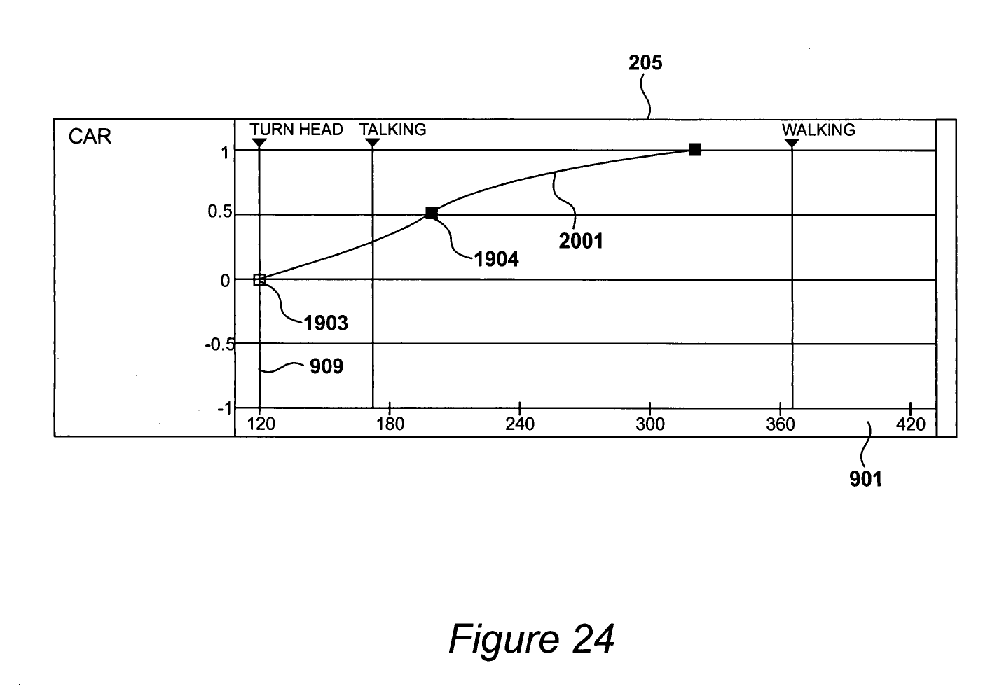

FIG. 24

FIG. 24 shows the animation curve 2001 in timeline 205 shown in FIG. 20, after the movement of cue marker 909. Keyframe 1903 has moved to the 120-frame point together with cue marker 909, thus stretching animation curve 2001 between keyframes 1903 and 1904.

1. An apparatus for image data processing, comprising:
(a) memory means that comprises animation data, wherein the animation data comprises:
(i) a plurality of attributes each having at least one keyframe and each keyframe having a time value; and
(ii) a plurality of cue points each having a time value, wherein a cue point is associated with one or more keyframes having the same time value;
(b) processing means configured to change the time value of one of the plurality of cue points, wherein the change to the time value of the cue point changes the time values of the cue point's associated keyframes.

2. The apparatus according to claim 1, wherein said processing means is further configured to:
display video data on a display means;
receive, via manual input means, input indicating that a new cue point is to be created;
identify the time relative to said video data at which said input is received; and
create a new cue point at said time.

3. The apparatus according to claim 1, wherein said processing means is further configured to:
receive, via manual input means, first input data specifying an attribute;
receive, via said manual input means, second input data specifying a time;
create a new cue point having said specified time as its time value;
create a new keyframe for said specified attribute, wherein said keyframe has said specified time as its time value; and
associate said new cue point with said new keyframe.

4. The apparatus according to claim 1, wherein said processing means is further configured to:
receive, via manual input means, first input data comprising a selection of a keyframe and a time;
select a cue point that has a time value within a specified number of frames of said time;
change the time value of said selected keyframe to be the time value of said selected cue point; and
associate said selected keyframe with said selected cue point.

5. The apparatus according to claim 1, wherein said memory means additionally comprises object data and at least one of said plurality of attributes is associated with an object.

6. The apparatus according to claim 1, wherein said memory means additionally comprises image data and one of said plurality of attributes controls the playback of said video data.

7. The apparatus according to claim 1, wherein said memory means additionally comprises audio data and one of said plurality of attributes controls the playback of said audio data.

8. The apparatus according to claim 1, wherein said processing means is further configured to search data for said cue points to identify all keyframes associated with one or more specified cue points and select the attributes said identified keyframes belong to.

9. The apparatus according to claim 1, wherein each of said plurality of cue points is displayed as a cue marker on a timeline displayed on a display means.

10. The apparatus according to claim 9, wherein said time value of a cue point is changed by using a manual input means to move, on said timeline, the cue marker corresponding to said cue point.

11. A method of processing image data comprising:
(a) associating object data with animation data, wherein said animation data comprises:
(i) a plurality of attributes, each having at least one keyframe, each keyframe having a time value; and
(ii) a plurality of cue points, each having a time value, wherein a cue point is associated with one or more keyframes having the same time value;
(b) receiving input data specifying a new time value for a specified one of said cue points;
(c) changing the time value of said specified cue point to said new time value; and
(d) changing the time values of the keyframes associated with said cue point to said new time value.

12. The method of processing image data according to claim 11, said method further comprising:
displaying video data on a display means;
receiving, via manual input means, input indicating that a new cue point is to be created;
identifying the time relative to said video data at which said input is received; and
creating a new cue point at said time.

13. The method of processing image data according to claim 11, said method further comprising:
receiving first input data specifying one of said attributes;
receiving second input data specifying a time;
creating a new cue point having said specified time as its time value;
creating a new keyframe for said specified attribute, wherein said keyframe has said specified time as its time value; and
associating said new cue point with said new keyframe.

14. The method of processing image data according to claim 11, said method further comprising:
receiving first input data specifying one of said attributes;
receiving second input data specifying one of said cue points;
creating a new keyframe for said specified attribute, wherein said keyframe has the same time value as said specified cue point; and
associating said new keyframe with said specified cue point.

15. The method of processing image data according to claim 11, said method further comprising:
receiving first input data comprising a selection of a keyframe and a time;
selecting a cue point that has a time value within a specified number of frames of said time;
changing the time value of said selected keyframe to be the time value of said selected cue point; and
associating said selected keyframe with said selected cue point.

16. The method of processing image data according claim 11, wherein animation data is additionally associated with image data and one of said attributes controls the playback of said video data.

17. The method of processing image data according to claim 11, wherein animation data is additionally associated with audio data and one of said attributes controls the playback of said audio data.

18. The method of processing image data according to claim 11, said method further comprising:
searching data for said cue points to identify all keyframes associated with one or more specified cue points; and
selecting the attributes said identified keyframes belong to.

19. The method of processing image data according to claim 11, said method further comprising displaying, on a display means, each of said cue points as a cue marker on a timeline.

20. The method of processing image data according to claim 19, said method further comprising:
moving a cursor on a display means in response to user input;
moving a cue marker on said timeline in response to said cursor movement; and
changing the time value of the cue point corresponding to the cue marker in response to said cue marker movement.

21. A computer-readable medium having computer-readable instructions executable by a computer to perform a method of processing image data, the method comprising:
(a) associating object data with animation data, wherein said animation data comprises:
(i) a plurality of attributes, each having at least one keyframe and each keyframe having a time value, and
(ii) a plurality of cue points, each having a time value, wherein a cue point is associated with one or more keyframes having the same time value;
(b) receiving input data specifying a new time value for a specified one of said cue points;
(c) changing the time value of said specified cue point to said new time value; and
(d) changing the time values of the keyframes associated with said cue point to said new time value.

22. The computer-readable medium having computer-readable instructions according to claim 21, the method further comprising:
displaying video data on a display means;
receiving, via manual input means, input indicating that a new cue point is to be created;
identifying the time relative to said video data at which said input is received; and
creating a new cue point at said time.

23. The computer-readable medium having computer-readable instructions according to claim 21, the method further comprising:
receiving first input data specifying one of said attributes;
receiving second input data specifying a time;
creating a new cue point having said specified time as its time value;
creating a new keyframe for said specified attribute, wherein said keyframe has said specified time as its time value; and
associating said new cue point with said new keyframe.

24. The computer-readable medium having computer-readable instructions according to claim 21, the method further comprising:
receiving first input data specifying one of said attributes;
receiving second input data specifying one of said cue points;
creating a new keyframe for said specified attribute, wherein said keyframe has the same time value as said specified cue point; and
associating said new keyframe with said specified cue point.

25. The computer-readable medium having computer-readable instructions according to claim 21, the method further comprising:
receiving first input data comprising a selection of a keyframe and a time;
selecting a cue point that has a time value within a specified number of frames of said time;
changing the time value of said selected keyframe to be the time value of said selected cue point; and
associating said selected keyframe with said selected cue point.

26. The computer-readable medium having computer-readable instructions according to claim 21, wherein animation data is additionally associated with video data and one of said attributes controls the playback of said video data.

27. The computer-readable medium having computer-readable instructions according to claim 21, wherein animation data is additionally associated with audio data and one of said attributes controls the playback of said audio data.

28. The computer-readable medium having computer-readable instructions according to claim 21, the method further comprising:
searching data for said cue points to identify all keyframes associated with one or more specified cue points; and
selecting the attributes said identified keyframes belong to.

29. The computer-readable medium having computer-readable instructions according to claim 21, the method further comprising displaying, on a display means, each of said cue points as a cue marker on a timeline.

30. The computer-readable medium having computer-readable instructions according to claim 29, the method further comprising:
moving a cursor on the display means in response to user input;
moving a cue marker on said timeline in response to said cursor movement; and
changing the time value of the cue point corresponding to the cue marker in response to said cue marker movement.
